(19) United States
(12) Patent Application Publication
(10) Pub. No.: US 2007/0089077 A1
(43) Pub. Date: Apr. 19, 2007

(54) System and method for integrated circuit timing analysis

(76) Inventor: Takashi Sumikawa, Osaka (JP)

Correspondence Address: MCDERMOTT WILL & EMERY LLP, 600 13TH STREET, N.W., WASHINGTON, DC, 20005-3096, US

(21) Appl. No.: 11/451,308

(22) Filed: Jun. 13, 2006

(30) Foreign Application Priority Data
Oct. 17, 2005 (JP) 2005-301442

(51) Int. Cl. G06F 17/50

(52) U.S. Cl. 716/6

(57) ABSTRACT

An integrated circuit timing analysis system includes: a first storage section for storing a layout of an integrated circuit including a plurality of transistors; and a processing section for processing the layout stored in the first storage section. The processing section includes a layout dividing section for dividing the layout stored in the first storage section into a plurality of sublayouts, a timing analysis section for performing statistical timing analysis on each of the sublayouts and a data compilation section for compiling the analysis data of the sublayouts to determine a timing of the integrated circuit.

### CROSS-REFERENCE TO RELATED APPLICATION

This non-provisional application claims priority under 35 U.S.C. §119(a) of Japanese Patent Application No. 2005-301442 filed in Japan on Oct. 17, 2005, the entire contents of which are hereby incorporated by reference.

### BACKGROUND OF THE INVENTION

1. Field of the Invention

The present invention relates to a system and method for integrated circuit timing analysis. In particular, it relates to a system and method for statistical static timing analysis taking delay variation statistics into account.

2. Description of Related Art

The most important issue for integrated circuit (IC) design is always timing verification. Circuit designers devote many hours to achieve intended circuit performance. So far, various automatic design environments have been proposed to reduce the hours and enhance the efficiency of timing analysis. Examples thereof include electronic design automation (EDA) tools, such as PrimeTime by Synopsis, Blast Logis by MAGMA and SST Velocity by Graphics.

As finer design rules have been used to improve the performance of the ICs, variations in characteristic of the ICs are significantly coming to the surface. The variations may be caused through production processes or by environmental changes.

The process variations are derived from variations in electric characteristics of transistors that occur in the upstream steps of producing the ICs on a wafer. Further, the process variations also occur in the downstream steps of sealing the IC chips produced in the upstream steps in various kinds of packages and inspecting them.

In the steps of producing the ICs, the production conditions fluctuate and the fluctuation has effect on the shapes and physical conditions of circuit elements. Therefore, characteristic variations of the semiconductor integrated circuits are inevitable. Specifically, it is impossible to completely control physical variations, such as variations in gate length, gate width and thickness of oxide films of the transistors through the production steps. Further, as the ICs are miniaturized to a further degree and the physical dimension of the semiconductor elements becomes small, the variations increase inversely. Moreover, if metal layers and interlayer insulating films vary in thickness, wiring is affected. Therefore, such variations lead to variations in wiring delay, as well as in gate delay.

The variations by environmental changes are derived from environmental factors, such as temperature and power supply voltage. The environmental variations also occur inevitably and cannot be avoided.

The above-described different kinds of variations have effect on timing. Therefore, timing verification must be performed in consideration of such variations. According to conventional timing verification taking the influence of the variations into account, circuit performance is determined by executing static timing analysis in a worst case. In this verification, the circuit performance is pessimistically estimated far lower than actual performance because some of different variation factors are defined as worst case conditions.

In order to avoid the pessimistic estimate of the circuit performance, there is a technique of performing statistical or stochastic timing analysis (for example, see the specifications of U.S. Patent Applications Nos. 2004/0243954 and 2005/0066298). According to the statistical static timing analysis (SSTA), delay time, arrival time and slack time are regarded not as constants but as probability distribution. Accordingly, complete probability distribution of the circuit performance influenced by the variations is predicted by the timing analysis.

In the conventional timing verification, however, a huge number of paths must be analyzed because the number of paths to be analyzed increases exponentially due to the miniaturization of the IC. All the variation factors must be considered accurately to statistically or stochastically analyze the timing, or the analysis result will be meaningless. However, in order to analyze all the variation factors with accuracy, the complexity of the timing verification increases exponentially. Thus, the conventional statistic timing analysis takes enormous time.

The IC characteristic may also be varied by random factors and systematic factors. For example, the number of impurities is fluctuated randomly because the number of impurities in a channel is reduced due to the miniaturization, thereby causing variations in transistor characteristic. The transistor characteristic is also varied by systematic factors derived from the layout of the cells. In order to analyze the random and systematic factors at one time, the complexity of the timing analysis increases to a further degree. Therefore, according to the conventional statistical timing analysis, it is actually impossible to analyze the random and systematic factors altogether.

### SUMMARY OF THE INVENTION

To solve the above-described problems, an object of the present invention is to achieve a timing analysis system and method which make it possible to perform statistical timing analysis at high speed without decreasing the accuracy in timing analysis of an integrated circuit.

To achieve the above-described object, according to the timing analysis system of the present invention, a layout of an integrated circuit is divided into sublayouts and statistical timing analysis is performed on the sublayouts.

Specifically, a first timing analysis system according to the present invention includes: a first storage section for storing a layout of an integrated circuit including a plurality of transistors; and a processing section including a layout dividing section for dividing the layout stored in the first storage section into a plurality of sublayouts, a timing analysis section for performing statistical timing analysis on each of the sublayouts and a data compilation section for compiling the analysis data of the sublayouts to determine a timing of the integrated circuit.

According to the first timing analysis of the present invention, the statistical timing analysis is performed on the limited number of paths. Therefore, the timing analysis is performed in a short time while the variation factors are taken into account with accuracy. Thus, the circuit design is carried out with improved efficiency.

It is preferred that the first timing analysis system of the present invention further includes: a second storage section for storing variation information concerning a variation factor of the integrated circuit; a third storage section for storing a delay model which is a function of the variation factor and represents a delay in the integrated circuit; and an input section for inputting a timing condition for the integrated circuit, wherein the timing analysis section performs statistical timing analysis on each of the sublayouts using the variation information stored in the second storage section, the delay model stored in the third storage section and the timing condition input by the input section.

In the first timing analysis system of the present invention, it is preferred that the variation factor includes a random factor and a systematic factor and the timing analysis section performs timing analysis on the sublayouts using at least one of the random factor and the systematic factor.

In the first timing analysis system of the present invention, it is preferred that the layout dividing section divides the layout into the sublayouts such that the sublayouts have the same area. By so doing, the position of a problematic sublayout is easily identified.

In the first timing analysis system of the present invention, it is preferred that the processing section includes an interpolation calculation section for performing interpolation calculation of the timing of boundary regions between the sublayouts. Due to the presence of the interpolation calculation section, error in timing analysis on the boundary regions of the sublayouts is reduced and the timing analysis is performed accurately on the integrated circuit.

In the first timing analysis system of the present invention, it is preferred that the data compilation section outputs the timing of the integrated circuit as a weighted sum of probability distribution of the variation factor. The timing of the integrated circuit may be output as a root sum square of probability distribution of the variation factor.

A second timing analysis system of the present invention includes: a first storage section for storing a layout of an integrated circuit including a plurality of transistors; and a processing section including a layout dividing section for dividing the layout stored in the first storage section into a plurality of sublayouts and a timing analysis section for statistically determining a timing of each of the sublayouts, wherein the timing analysis section includes a preliminary analysis section for performing timing analysis on each of the sublayouts based on a predetermined condition, a path extraction section for identifying sublayouts whose analysis results by the preliminary analysis section correspond with a predetermined timing condition to extract a critical signal path and a statistical timing analysis section for performing statistical timing analysis on the critical path extracted by the path extraction section.

According to the second timing analysis system of the present invention, the timing analysis is performed at high speed because time-consuming statistical analysis is performed on a limited path. Further, as the preliminary analysis is performed in advance to extract a critical path, timing analysis is performed accurately on the critical path which requires accuracy.

In the second timing analysis system of the present invention, it is preferred that the preliminary analysis section performs timing analysis on each of the sublayouts based on a standard condition. The preliminary analysis section may perform timing analysis on each of the sublayouts based on a worst condition.

A first timing analysis method of the present invention includes the steps of: (a) extracting a layout of an integrated circuit including a plurality of transistors; (b) dividing the layout into a plurality of sublayouts; (c) performing statistical timing analysis on each of the sublayouts; and (d) compiling the analysis data of the sublayouts to determine the timing of the integrated circuit.

According to the first timing analysis method of the present invention, time-consuming timing analysis is performed with respect to a small range. Therefore, the variation factors are accurately considered and the analysis is achieved in a short time. As a result, the circuit design is carried out with improved efficiency.

It is preferred that the first timing analysis method of the present invention further includes the steps preceding the step (c) of: collecting variation information concerning a variation factor of the integrated circuit; preparing a delay model which is a function of the variation factor and represents a delay in the integrated circuit; and setting a timing condition for the integrated circuit, wherein in the step (c), statistical timing analysis is performed on the sublayouts using the timing condition and the variation information.

In the first timing analysis method of the present invention, it is preferred that the variation factor includes a random factor and a systematic factor and the timing analysis section performs timing analysis on the sublayouts using at least one of the random factor and the systematic factor.

In the first timing analysis method of the present invention, it is preferred that the layout is divided into the sublayouts in the step (b) such that the sublayouts have the same area.

In the first timing analysis method of the present invention, it is preferred that interpolation calculation of the timing of boundary regions between the sublayouts is performed in the step (c).

In the first timing analysis method of the present invention, it is preferred that the timing of the integrated circuit is output as a weighted sum of probability distribution of the variation factor in the step (d). The timing of the integrated circuit may be output as a root sum square of probability distribution of the variation factor in the step (d).

A second timing analysis method of the present invention includes the steps of: (a) extracting a layout of an integrated circuit including a plurality of transistors; (b) dividing the layout into a plurality of sublayouts; (c) performing statistical timing analysis on each of the sublayouts; and (d) compiling a timing of each of the sublayouts as a timing of the integrated circuit, wherein the step (c) includes: the preliminary analysis step of performing preliminary timing analysis on each of the sublayouts based on a predetermined condition; the path extraction step of identifying sublayouts whose analysis results by the preliminary analysis step correspond with a predetermined timing condition to extract a critical signal path; and the statistical timing analysis step of performing statistical timing analysis on the critical path extracted in the path extraction step.

According to the second timing analysis method of the present invention, a path to be subjected to time-consuming statistical timing analysis is limited in advance. Therefore, the variation factors are accurately considered and the analysis is achieved in a short time. As a result, the circuit design is carried out with improved efficiency. Further, as the statistical timing analysis is performed on a critical path which requires accurate timing analysis, circuit performance is estimated with accuracy.

In the second timing analysis method of the present invention, it is preferred that the timing analysis is performed on each of the sublayouts based on a standard condition in the preliminary analysis step. The timing analysis may be performed on each of the sublayouts based on a worst condition in the preliminary analysis step.

### BRIEF DESCRIPTION OF THE DRAWINGS

FIG. 1 is a flowchart illustrating a method for integrated circuit timing analysis according to a first embodiment of the present invention.

FIG. 2 is a view illustrating how a layout is divided into sublayouts according to the integrated circuit timing analysis method of the first embodiment of the present invention.

FIG. 3 is a block diagram illustrating a system for integrated circuit timing analysis according to the first embodiment of the present invention.

FIG. 4 is a view illustrating variation factors according to the integrated circuit timing analysis method of the first embodiment of the present invention.

FIG. 5 is a flowchart illustrating a modified method for integrated circuit timing analysis according to the first embodiment of the present invention.

FIG. 6 is a view illustrating interpolation on the boundaries of the sublayouts according to the modified integrated circuit timing analysis method of the first embodiment of the present invention.

FIG. 7 is a block diagram illustrating a modified system for integrated circuit timing analysis according to the first embodiment of the present invention.

FIG. 8 is a flowchart illustrating a method for integrated circuit timing analysis according to a second embodiment of the present invention.

FIG. 9 is a view illustrating how to determine a critical path according to the integrated circuit timing analysis method of the second embodiment of the present invention.

FIG. 10 is a block diagram illustrating an integrated circuit timing analysis system according to the second embodiment of the present invention.

### DETAILED DESCRIPTION OF THE INVENTION

### FIRST EMBODIMENT

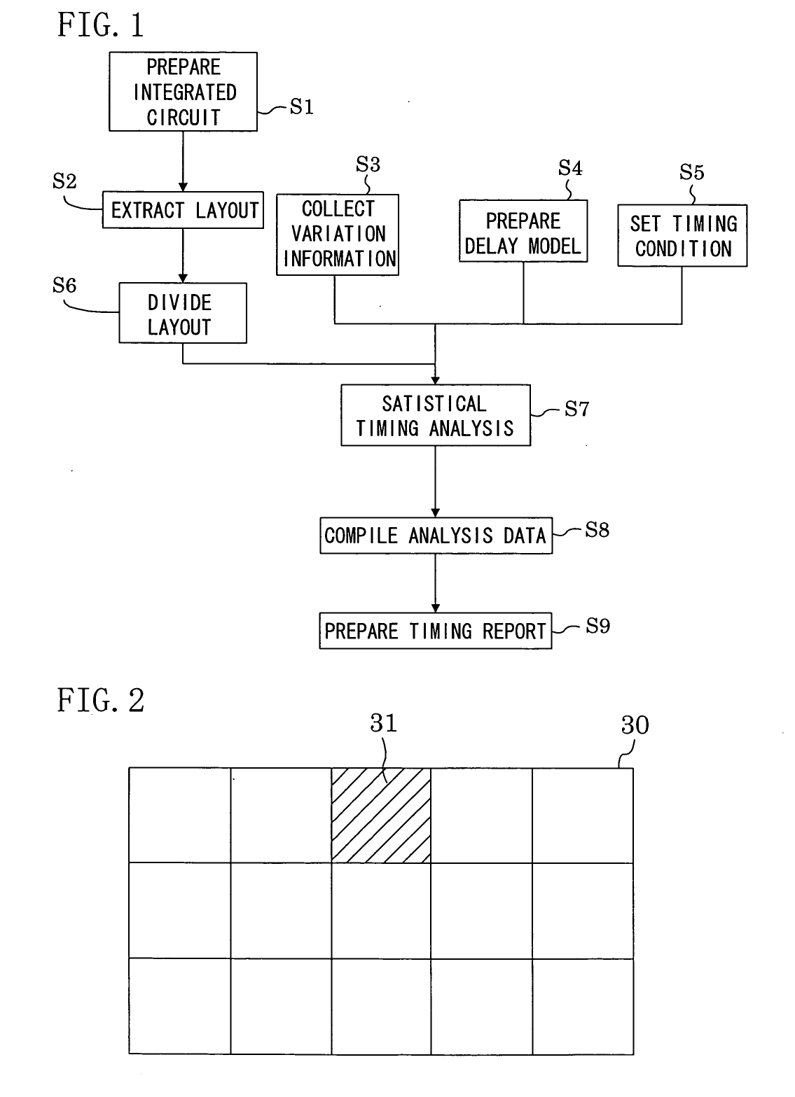

A first embodiment of the present invention will be explained with reference to the drawings. FIG. 1 is a flowchart illustrating a method for integrated circuit timing analysis according to the first embodiment.

First, in step S1, an integrated circuit (IC) for determining the timing is prepared. Then, in step S2, an IC layout containing information about cells including elements such as transistors incorporated in the prepared IC and information about wires for electrically connecting the cells is extracted. The layout contains information about the positions and sizes of the elements and the wires included in the IC.

Simultaneously, in step S3, variation information concerning variation factors is collected. The variation information includes information about factors related to elements such as gate length, gate width, thickness of oxide films, threshold voltage, capacitance value and resistance value, as well as information about factors related to wiring such as wiring resistance and wiring capacitance. Each of these factors is represented as a value uniquely determined according to its characteristic or a value including format information such as probability distribution. For example, these factors may be expressed as an average value, a center value, a maximum value, a minimum value and a standard deviation.

In step S4, a delay model for evaluating the timing variations caused by the variation factors is prepared. The delay model may be determined as a function of the variation factors such that it corresponds to a display form of the variations. The delay model may be prepared in the form of an analytical calculation formula or a table model.

In step S5, a timing condition is established which is information about arrival time under the requirement used for the analysis, clock phase and input/output load.

The extraction of the IC layout in step S2 may be performed in the same manner as in the conventional timing analysis. As the variation information, delay model and timing condition, any required item may be selected from the items used in the conventional timing analysis depending on the IC to be analyzed and the purpose of the analysis. A combination of two or more items or a single item may be used.

In step S6, a layout is divided. Specifically, a layout 30 extracted from the IC information in step S2 is divided into a plurality of sublayouts 31 as shown in FIG. 2. Referring to FIG. 2, an original circuit block is equally divided into a matrix of five columns and three rows. Therefore, the area of each of the sublayouts 31 is one fifteenth of the area of the layout 30. When two variation factors are combined, time taken to analyze the sublayout 31 is less than one fifteenth of the time taken to analyze the layout 30. If three or more the variations are combined for improvement in accuracy of the analysis, time taken to analyze the whole layout increases, but the time taken to analyze the sublayout 31 is less than one fifteenth of the time taken to analyze the layout 30.

The number of the sublayouts 31 is determined based on the size and complexity of the IC, i.e., the layout 30. If the layout 30 includes 10,000,000 cells and ten variation factors are combined, about 100,000 cells are contained in a single sublayout 31. By so doing, the speed and accuracy of the timing analysis performed later fall in a practical range.

In step S7, the divided sublayouts are subjected to statistical timing analysis using the variation information, delay model and timing condition.

In the statistical timing analysis, the timing is not expressed as a uniquely identified number but as probability distribution. The timing may be displayed in various forms. For example, it may be expressed as an average value, a center value, a maximum value, a minimum value, a standard deviation, a timing graph and an approximation model of the timing. Analysis of sensitivity of the timing to the variation factors (the degree of influence on the timing by the variation factor) is also included. If the timing analysis is performed while all pieces of the information are covered, a problem may arise in convergence of the analysis because the amount of information becomes enormous. According to the timing analysis system of the present embodiment, however, the analysis is performed on the divided sublayouts, respectively. Accordingly, the amount of information required for a single analysis is reduced. Therefore, the occurrence of the problem of the convergence is avoided.

In step S8, data of the statistical timing analysis performed on each of the sublayouts are compiled to determine the timing of the IC. The compilation of the timing analysis data is performed by weighted-summing or root-sum-squaring the combinations of stochastic timing in each of the sublayouts. For example, if stochastic timing analysis is performed on each of the sublayouts such that the timing analysis results of the sublayouts are compiled as the data, weighted-summing is performed. On the other hand, if stochastic timing analysis is performed on each of the sublayouts such that the timing of each sublayout is statistically recognized in the form of a sum of a center value and a standard deviation, root-sum-squaring is preferred.

In step S9, a timing report is prepared from the determined timing of the IC. The timing report includes arrival time, slack time and slew rate at the nodes of the IC.

According to the timing analysis method of the present embodiment, the layout is divided into a plurality of sublayouts, the statistical timing analysis is performed on each of the divided sublayouts, and then the timing analysis data of the sublayouts are compiled to determine the timing of the IC. Therefore, the amount of information required to perform the statistical timing analysis is reduced. Thus, as compared with the statistical timing analysis performed on the whole IC, time taken for the timing analysis is significantly reduced. As a result, the efficiency in designing the IC improves. Further, the influence of the variation factors on the timing is also analyzed.

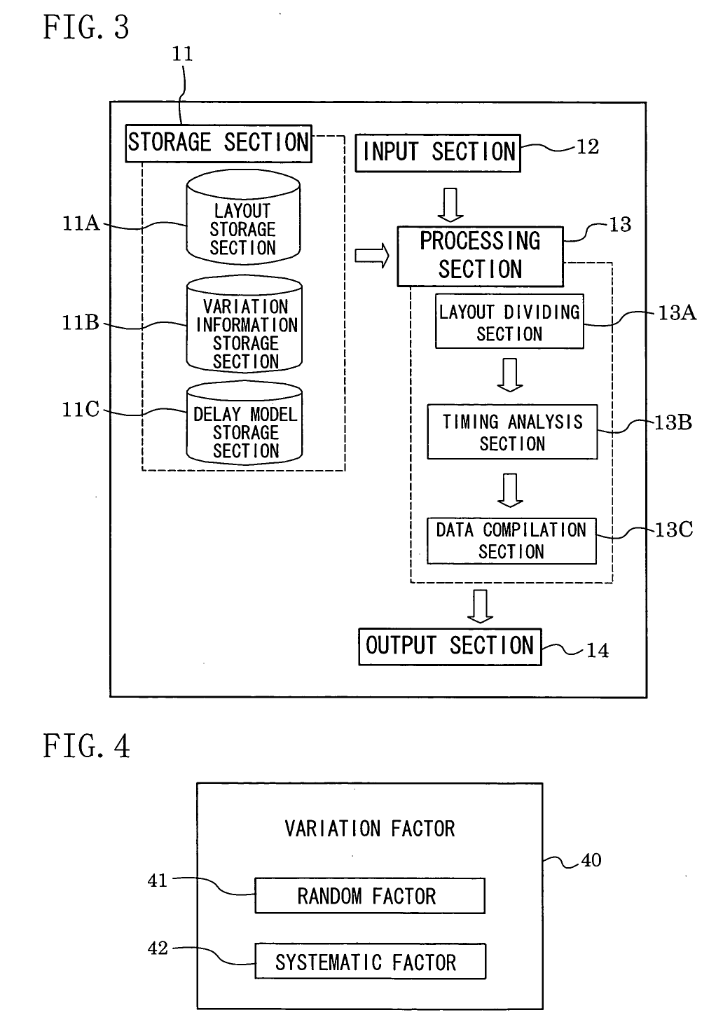

Hereinafter, an explanation of a system for integrated circuit timing analysis according to the first embodiment will be provided with reference to the drawings. FIG. 3 illustrates the integrated circuit timing analysis system according to the present embodiment. As shown in FIG. 3, the timing analysis system of the present embodiment includes four sections, i.e., a storage section 11, an input section 12, a processing section 13 and an output section 14.

The storage section 11 includes a layout storage section 11A for storing the layout of the IC to be subjected to the timing analysis, a variation information storage section 11B for storing the variation information concerning the variation factors and a delay model storage section 11C for storing a delay model used for the timing analysis.

The input section 12 inputs information about arrival time, a clock phase and an input/output load under the requirement used for the analysis as a timing condition.

The processing section 13 includes a layout dividing section 13A, a timing analysis section 13B and a data compilation section 13C and performs timing analysis using the information stored in the storage section 11 and the information input by the input section 12.

The layout dividing section 13A divides the layout stored in the layout storage section 11A into a plurality of sublayouts. The timing analysis section 13B performs statistical timing analysis on each of the sublayouts using the variation information stored in the variation information storage section 11B, the delay model stored in the delay model storage section 11C and the timing condition input by the input section 12. At this time, timing analysis is simultaneously performed on each of the sublayouts. The data compilation section 13C compiles the analysis results of the sublayouts. The compilation of the timing analysis data is performed by weight-summing or root-sum-squaring the combination of stochastic timings of each of the sublayouts.

The output section 14 outputs the timing of the integrated circuit obtained in the processing section 13 in the form of a timing report. The timing report includes the information of the integrated circuit and the corresponding timing information.

With the thus-configured analysis system, statistical timing analysis is performed on the IC with efficiency by the timing analysis method of the present embodiment.

In the timing analysis method of the present embodiment, the information about the transistors and wires is given as the variation information. However, the information may be given in the other way. For example, as shown in FIG. 4, a variation factor 40 may be divided into a random factor 41 and a systematic factor 42 and each of them may be given as the information.

The random factor 41 is a variation factor which occurs randomly due to process fluctuation and expressed as a stochastic variable having an average value or a center value and a standard deviation or a variance of the variation factor.

The systematic factor 42 is a variation factor concerning the layout itself or the shape of the cells forming the layout. For example, the systematic factor 42 is related to a change in transistor characteristic caused by stress of STI (shallow trench isolation). The systematic factor is not limited to the influence on the transistor characteristic caused by the shapes of a gate electrode and an active region of the cell. It also includes the influence on the transistor characteristic by adjacent cells or other cells than the cell. The systematic factor is expressed as a uniquely identified value. However, the value may be determined within a certain range as in the case of uniform distribution.

As the random factor and the systematic factor are considered simultaneously as the variation factors, statistical cancel effect between the random variation and the systematic variation is represented. Thus, the timing analysis is performed with high accuracy.

It may be possible to perform the timing analysis using only the random factor 41 or the systematic factor 42.

In the present embodiment, how to divide the layout into the sublayouts 31 is not particularly specified. The layout may be divided into the sublayouts 31 having the same area.

If the sublayouts 31 have the same area, the positions of the sublayouts on the layout are precisely identified. This makes it possible to determine where the sublayout showing critical timing is located on the layout. Therefore, the timing analysis results are easily fed back to the circuit design. The divided sublayouts may be provided with coordinates.

### MODIFICATION OF FIRST EMBODIMENT

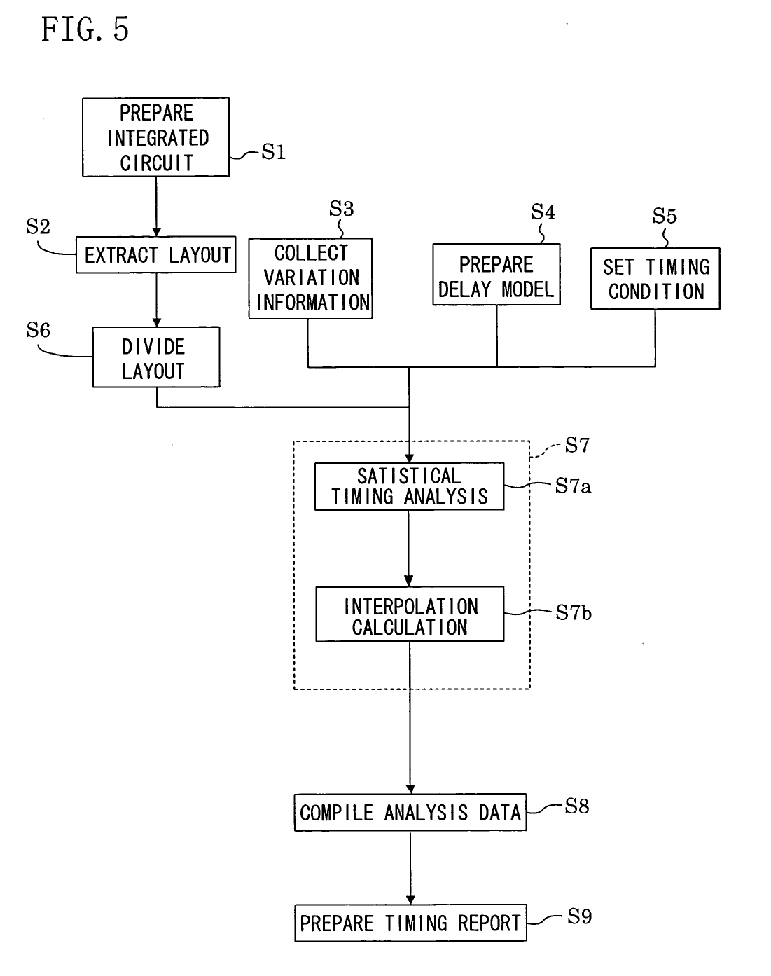

Hereinafter, a modification of the first embodiment will be explained with reference to the drawings. FIG. 5 is a flowchart illustrating a modified method for integrated circuit timing analysis. The modified timing analysis method is different from the timing analysis method of the first embodiment in that step S7 includes substep S7a for performing statistical timing analysis on each of the divided sublayouts and substep S7b for performing interpolation calculation of the boundary regions between the sublayouts. Other steps than step S7 are not explained below because they are the same as those of the first embodiment.

In the timing analysis performed on each of the sublayouts, information about connection between boundary regions of the sublayouts and the sublayouts adjacent thereto is lacking. Therefore, error occurs in the analysis results. To eliminate the error, another timing analysis is performed on the boundary regions to perform interpolation calculation of the timing analysis on the boundary regions. By so doing, the occurrence of error in the compilation of the timing analysis data to determine the timing of the IC is reduced.

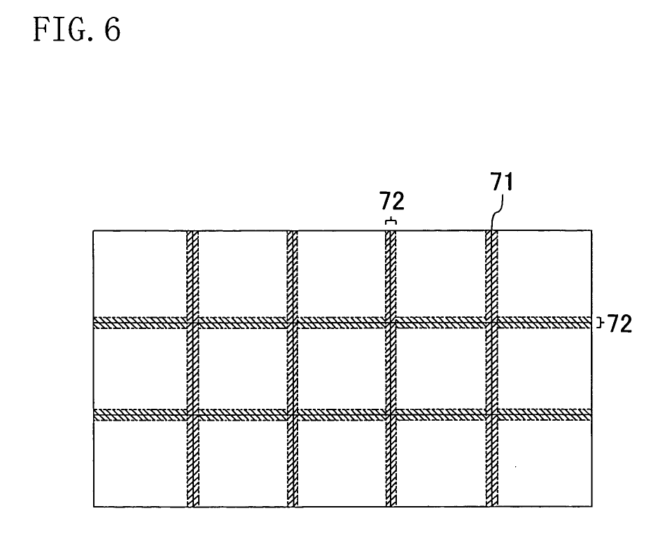

As shown in FIG. 6, interpolation calculation regions 72 are defined on the boundaries 71 of the divided sublayouts and statistical timing analysis is performed on each of the interpolation calculation regions 72. The interpolation calculation regions 72 may be defined on a voluntary basis. For example, each of the interpolation calculation regions 72 may be defined to include two adjacent cells sandwiching the boundary 71 and the wires between the two cells. Each of the interpolation calculation regions 72 includes only two sublayouts such that the interpolation calculation is performed on the two sublayouts.

As the interpolation calculation regions 72 are divided small, time increased to perform the interpolation calculation is minimized as possible. The interpolation calculation is not limited to the statistical timing analysis and may be carried out using an analytical calculation formula or a table model.

The above-described modified timing analysis method makes it possible to improve the timing accuracy at the boundary regions by performing the interpolation calculation on the boundary regions of the sublayouts. Therefore, the accuracy of the timing analysis on the whole IC improves.

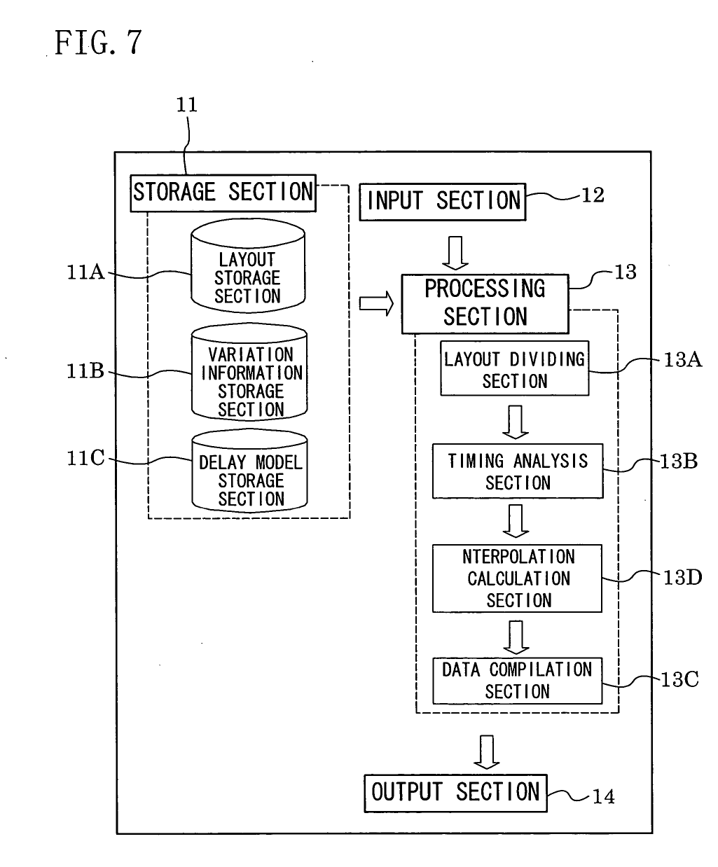

As shown in FIG. 7, a timing analysis system for executing the modified timing analysis method is prepared by adding an interpolation calculation section 13D to the timing analysis system of the first embodiment. The interpolation calculation section 13D performs timing analysis on the interpolation calculation regions 72 for interpolation of the boundary regions of the sublayouts.

### SECOND EMBODIMENT

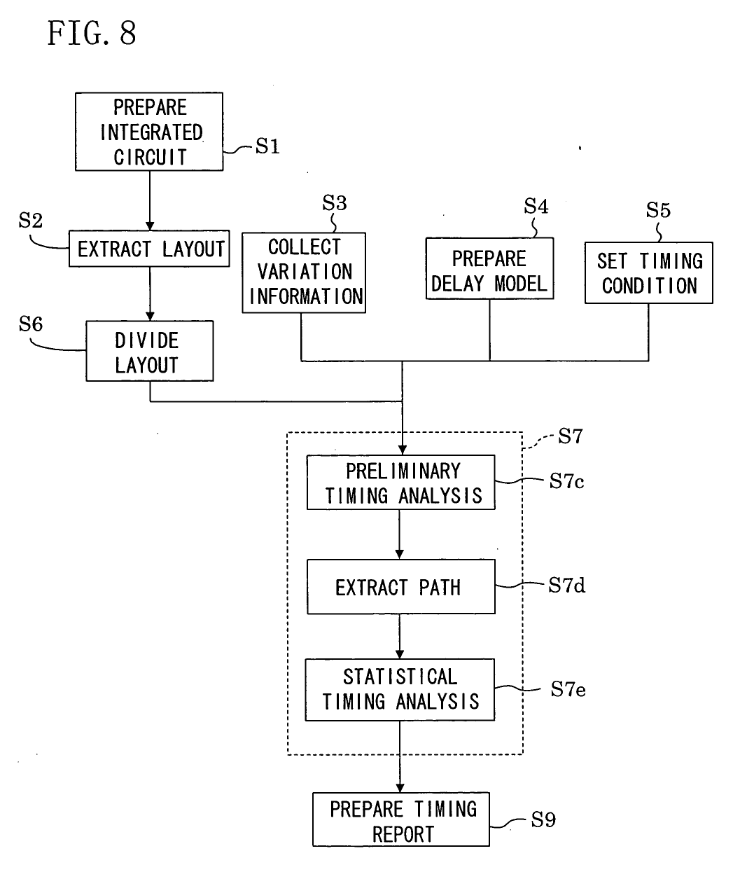

Hereinafter, an explanation of a second embodiment of the present invention will be provided with reference to the drawings. FIG. 8 shows a flowchart illustrating a method for integrated circuit timing analysis according to the present embodiment. Other steps than step S7 shown in FIG. 8 are not explained below because they are the same as those of the first embodiment.

In the timing analysis method of the present embodiment, step S7 for performing statistical timing analysis includes substep S7c for performing preliminary timing analysis, substep S7d for extracting a critical path and substep S7e for performing statistical timing analysis on the critical path.

In substep S7c, preliminary timing analysis is performed on each of the sublayouts under a predetermined standard condition.

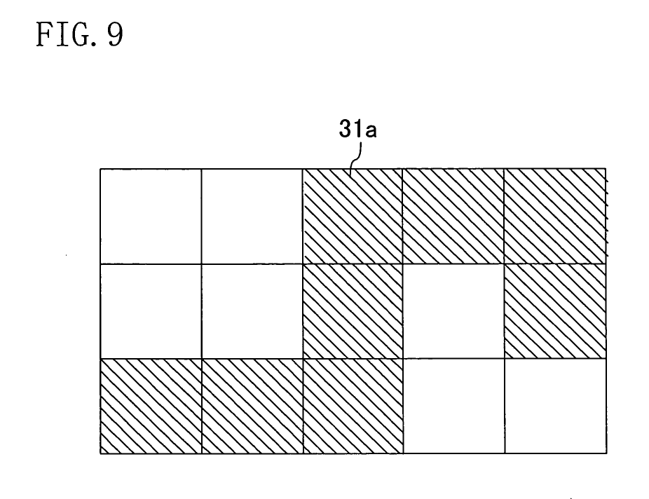

Then, in substep S7d, sublayouts showing critical timing are identified based on the results of the preliminary timing analysis. FIG. 9 shows the identified sublayouts showing the critical timing. In this case, as shown in FIG. 9, each of the sublayouts 31a showing the critical timing is brought into contact with another sublayout showing the critical timing. By so doing, at least one signal path is extracted by tracing the identified sublayouts. The extracted signal path is a critical path showing the most critical timing in the IC.

In substep S7e, statistical timing analysis is performed on the extracted signal path. Accordingly, information about the most critical timing in the IC is obtained.

In the present embodiment, first, timing analysis is performed on each of the sublayouts under the standard condition to extract the critical signal path. Then, statistical timing analysis is performed only on the extracted path. As the path to be subjected to the time-consuming statistical timing analysis is specified in advance, the timing analysis is performed at high speed. Further, as the critical signal path is subjected to the statistical timing analysis, the results of the timing analysis are accurate.

In the present embodiment, the timing analysis is performed under the standard condition to identify the critical sublayouts. However, the timing analysis may be performed under a worst condition.

The identification of the sublayouts showing the critical timing may be performed by various methods. For example, paths are generated through the layout and the sublayouts are selected in increasing order of the degree of analysis results. Alternatively, the sublayouts are ranked several levels and all the sublayouts in the worst rank are selected, and then additional sublayouts necessary to complete a path on the layout together with the selected sublayouts are selected.

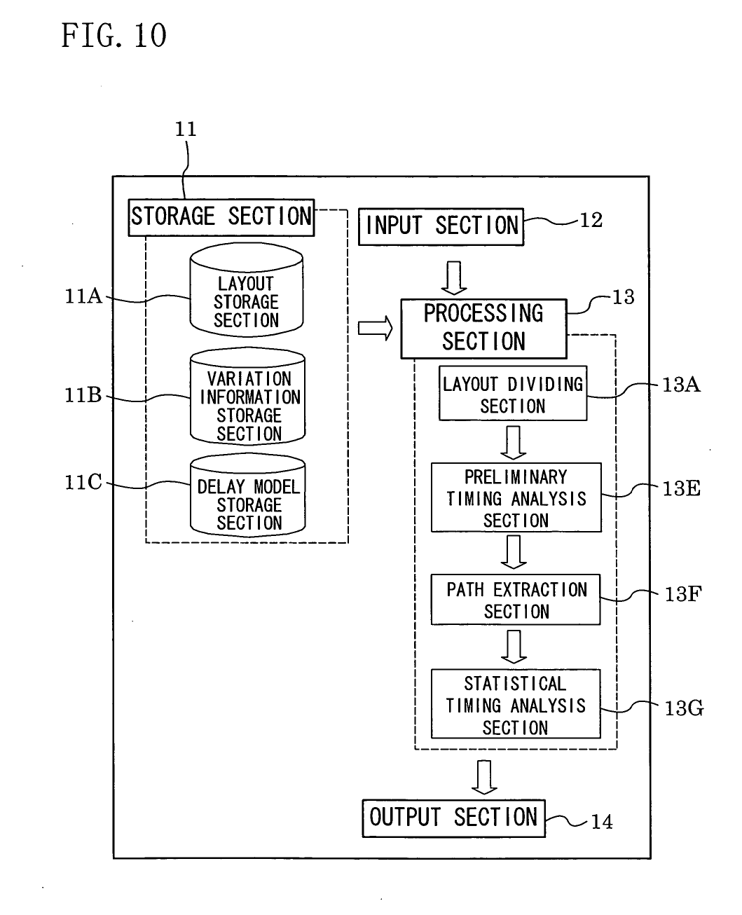

FIG. 10 illustrates a system for integrated circuit timing analysis according to the present embodiment. In FIG. 10, the same components as those shown in FIG. 3 are indicated by the same reference numerals to omit the explanation.

As shown in FIG. 10, in the timing analysis system of the present embodiment, a processing section 13 includes a layout dividing section 13A, a preliminary timing analysis section 13E, a path extraction section 13F and a statistical timing analysis section 13G.

On the sublayouts divided by the layout dividing section 13A, nonstatistical preliminary timing analysis is performed under a standard condition predetermined in the preliminary timing analysis section 13E.

The path extraction section 13F identifies a series of sublayouts showing critical timing based on the results of the preliminary timing analysis and a critical timing path is extracted from the identified sublayouts.

The statistical timing analysis section 13G performs statistical timing analysis on the critical path extracted by the path extraction section 13F to determine the most critical timing of the IC.

The standard condition mentioned in the present embodiment is the most typical condition for representing the transistor characteristic (center value). The worst condition is a condition that brings about the worst transistor characteristic.

As described above, the system and method for integrated circuit timing analysis according to the present invention effectively achieve a timing analysis system and a timing analysis method for performing statistical timing analysis at high speed without decreasing the accuracy in timing analysis on the integrated circuit. Thus, the present invention is useful for a system and method for statistical static timing analysis taking delay variation statistics into account.

What is claimed is:

1. An integrated circuit timing analysis system comprising:
a first storage section for storing a layout of an integrated circuit including a plurality of transistors; and
a processing section including a layout dividing section for dividing the layout stored in the first storage section into a plurality of sublayouts, a timing analysis section for performing statistical timing analysis on each of the sublayouts and a data compilation section for compiling the analysis data of the sublayouts to determine a timing of the integrated circuit.

2. The integrated circuit timing analysis system of claim 1 further comprising:
a second storage section for storing variation information concerning a variation factor of the integrated circuit;
a third storage section for storing a delay model which is a function of the variation factor and represents a delay in the integrated circuit; and
an input section for inputting a timing condition for the integrated circuit, wherein
the timing analysis section performs statistical timing analysis on each of the sublayouts using the variation information stored in the second storage section, the delay model stored in the third storage section and the timing condition input by the input section.

3. The integrated circuit timing analysis system of claim 2, wherein
the variation factor includes a random factor and a systematic factor and
the timing analysis section performs timing analysis on the sublayouts using at least one of the random factor and the systematic factor.

4. The integrated circuit timing analysis system of claim 1, wherein
the layout dividing section divides the layout into the sublayouts such that the sublayouts have the same area.

5. The integrated circuit timing analysis system of claim 1, wherein
the processing section includes an interpolation calculation section for performing interpolation calculation of the timing of boundary regions between the sublayouts.

6. The integrated circuit timing analysis system of claim 1, wherein
the data compilation section outputs the timing of the integrated circuit as a weighted sum of probability distribution of the variation factor.

7. The integrated circuit timing analysis system of claim 1, wherein
the data compilation section outputs the timing of the integrated circuit as a root sum square of probability distribution of the variation factor.

8. An integrated circuit timing analysis system comprising:
a first storage section for storing a layout of an integrated circuit including a plurality of transistors; and
a processing section including a layout dividing section for dividing the layout stored in the first storage section into a plurality of sublayouts and a timing analysis section for statistically determining a timing of each of the sublayouts, wherein
the timing analysis section includes a preliminary analysis section for performing timing analysis on each of the sublayouts based on a predetermined condition,
a path extraction section for identifying sublayouts whose analysis results by the preliminary analysis section correspond with a predetermined timing condition to extract a critical signal path and
a statistical timing analysis section for performing statistical timing analysis on the critical path extracted by the path extraction section.

9. The integrated circuit timing analysis system of claim 8, wherein
the preliminary analysis section performs timing analysis on each of the sublayouts based on a standard condition.

10. The integrated circuit timing analysis system of claim 8, wherein
the preliminary analysis section performs timing analysis on each of the sublayouts based on a worst condition.

11. An integrated circuit timing analysis method comprising the steps of:
(a) extracting a layout of an integrated circuit including a plurality of transistors;
(b) dividing the layout into a plurality of sublayouts;
(c) performing statistical timing analysis on each of the sublayouts; and
(d) compiling the analysis data of the sublayouts to determine a timing of the integrated circuit.

12. The integrated circuit timing analysis method of claim 11 further comprising the steps preceding the step (c) of:
collecting variation information concerning a variation factor of the integrated circuit;
preparing a delay model which is a function of the variation factor and represents a delay in the integrated circuit; and
setting a timing condition for the integrated circuit, wherein
in the step (c), statistical timing analysis is performed on the sublayouts using the timing condition and the variation information.

13. The integrated circuit timing analysis method of claim 11, wherein
the variation factor includes a random factor and a systematic factor and
the timing analysis section performs timing analysis on the sublayouts using at least one of the random factor and the systematic factor.

14. The integrated circuit timing analysis method of claim 11, wherein
the layout is divided into the sublayouts in the step (b) such that the sublayouts have the same area.

15. The integrated circuit timing analysis method of claim 1 1, wherein
interpolation calculation of the timing of boundary regions between the sublayouts is performed in the step (c).

16. The integrated circuit timing analysis method of claim 1 1, wherein
the timing of the integrated circuit is output as a weighted sum of probability distribution of the variation factor in the step (d).

17. The integrated circuit timing analysis method of claim 1 1, wherein
the timing of the integrated circuit is output as a root sum square of probability distribution of the variation factor in the step (d).

18. An integrated circuit timing analysis method comprising the steps of:
(a) extracting a layout of an integrated circuit including a plurality of transistors;
(b) dividing the layout into a plurality of sublayouts;
(c) performing statistical timing analysis on each of the sublayouts; and
(d) compiling a timing of each of the sublayouts as a timing of the integrated circuit, wherein
the step (c) includes:
the preliminary analysis step of performing preliminary timing analysis on each of the sublayouts based on a predetermined condition;
the path extraction step of identifying sublayouts whose analysis results by the preliminary analysis step correspond with a predetermined timing condition to extract a critical signal path; and
the statistical timing analysis step of performing statistical timing analysis on the critical path extracted in the path extraction step.

19. The integrated circuit timing analysis method of claim 18, wherein
the timing analysis is performed on each of the sublayouts based on a standard condition in the preliminary analysis step.

20. The integrated circuit timing analysis method of claim 18, wherein
the timing analysis is performed on each of the sublayouts based on a worst condition in the preliminary analysis step.
